(19) United States
(12) Patent Application Publication
(10) Pub. No.: US 2026/0257606 A1
(43) Pub. Date: Sep. 3, 2026

(54) COAL HAULER

(71) Applicant: KRESS CORPORATION, Brimfield, IL (US)

(72) Inventors: Richard Richardson, Brimfield, IL (US); Danny BOETTCHER, Brimfield, IL (US)

(73) Assignee: KRESS CORPORATION, Brimfield, IL (US)

(21) Appl. No.: 18/870,901

(22) PCT Filed: Jun. 2, 2023
(86) PCT No.: PCT/US2023/024343

§ 371 Date: Dec. 2, 2024

Related U.S. Application Data
(60) Provisional application No. 63/348,864, filed on Jun. 3, 2022.

(51) Int. Cl. B60P 1/56; B62D 21/03; B62D 27/02

(52) U.S. Cl. CPC B60P 1/56; B62D 21/03; B62D 27/023

(57) ABSTRACT

A coal hauler includes a plurality of ground engaging members, a motivator providing a driving force and a haul body supported on the ground engaging members. The haul body includes a pair of side assemblies, and front and rear haul body assemblies secured to the side assemblies and coupled together in a central portion by a center bulkhead structure with at least one selectively movable door selectively blocking the bottom opening to form a coal hauling chamber. The haul body further includes a plurality of support structures including at least one front support structure secured between each side assembly and the front haul body assembly, and at least one rear support structure secured between each side assembly and the rear haul body assembly. The front and rear support structures reinforce intersections of the front and rear haul body assemblies with the side assemblies along the coal hauling chamber.

### TECHNICAL FIELD

This patent disclosure relates generally to coal haulers and, more particularly to a coal hauler including a body structure having no separate frame.

### BACKGROUND

Coal haulers are large hauling vehicles that may be utilized to transport mined coal from one location to another. Coal haulers include a haul body that is supported on ground engaging structures such as a plurality of wheels. The haul body in a coal hauler often includes a bottom portion that may be selectively opened in order to provide a bottom dump of the payload into a structure or opening below.

It is desirable that coal haulers are maneuverable despite their large size. Further, while it is desirable to minimize the weight of a coal hauler in order to maximize the potential coal payload and therefore efficiency, the coal hauler must be sufficiently strong to support the extreme weight of the payload. This balance is particularly challenging in view of the extreme weight of a full coal payload.

### SUMMARY

The disclosure describes, in one aspect, a coal hauler that does not include a separate frame upon which the haul body is constructed. In another aspect, the disclosure describes a coal hauler including a plurality of reinforced joints including reinforcing structures that are welded to the haul body between the front, rear, and side structures. In yet another aspect, the disclosure describes a haul body wherein high frequency mechanical impact (HFMI) treatment method is utilized to enhance the integrity of such welds.

### BRIEF DESCRIPTION OF THE DRAWING(S)

FIG. 1 is a side elevational view of a coal hauler constructed in accordance with teachings of this disclosure.

FIG. 2 is a top isometric view of a haul body for the coal hauler of FIG. 1 constructed in accordance with teachings of this disclosure.

FIG. 3 is a side elevational view of the haul body of FIG. 2.

FIG. 4 is a top plan view of the haul body of FIGS. 2-3.

FIG. 5 is an isometric view of a side gusset of the haul body of FIGS. 2-4.

FIG. 6 is an isometric view of a rear corner wrapper of the haul body of FIGS. 2-4.

FIG. 7 is an isometric view of a front corner gusset of the haul body of FIGS. 2-4.

FIG. 8 is a side elevational view of a front inner formed plate of the haul body of FIGS. 2-4.

FIG. 9 is a side elevational view of a rear inner formed plate of the haul body of FIGS. 2-4.

FIG. 10 is an isometric view of a conical plate of the haul body of FIGS. 2-4.

FIG. 11 is an exemplary schematic cross-sectional view of weld structures along curved/conical sections of the haul body of FIGS. 2-4 taken along 11-11 in FIG. 3.

FIG. 12 is an exemplary schematic cross-sectional view of a weld structure along the front suspension beam structure of the haul body of FIGS. 2-4 taken along 12-12 in FIG. 4.

FIG. 13 is an exemplary schematic cross-sectional view of a weld structure along the center bulkhead of the haul body of FIGS. 2-4 taken along 13-13 in FIG. 2.

FIG. 14 includes a side elevational and top plan view of a triangular plate for the haul body of FIGS. 2-4.

### DETAILED DESCRIPTION

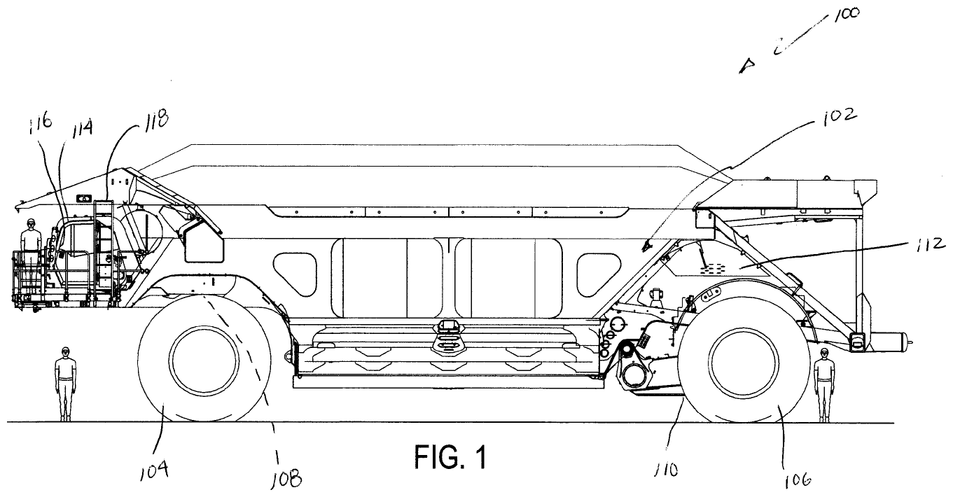

This disclosure relates to a coal hauler such as the coal hauler 100 of FIG. 1, which is commonly utilized for hauling coal. The coal hauler 100 includes a haul body 102 supported on ground engaging members 104, 106, such as wheels. The haul body 102 is supported on the front ground engaging members 104 by a front suspension system 108, and on the rear ground engaging members 106 by a rear suspension system 110. In at least one embodiment, the front ground engaging members 104 include two pairs of wheels supported on respective axles such that the respective axles may be pivoted to steer the coal hauler 100. In some embodiments, for example, the coal hauler 100 may be steered at angles up to 85°, providing exceptional maneuverability. The coal hauler 100 may additionally include a motivator such as an engine 112 for providing a driving force to at least one of the front or rear ground engaging members 104, 106.

The coal hauler 100 may include a cab 114, which may be supported on the haul body 102. The cab 114 may include operator controls 116, which may include, for example, a steering mechanism and a drive mechanism, and/or controls for operation of portions of the haul body 102. The coal hauler 100 may be provided with a ladder 118 or the like to facilitate operator access to the cab 114. In at least some embodiments, the ladder 118 is selectively retractable.

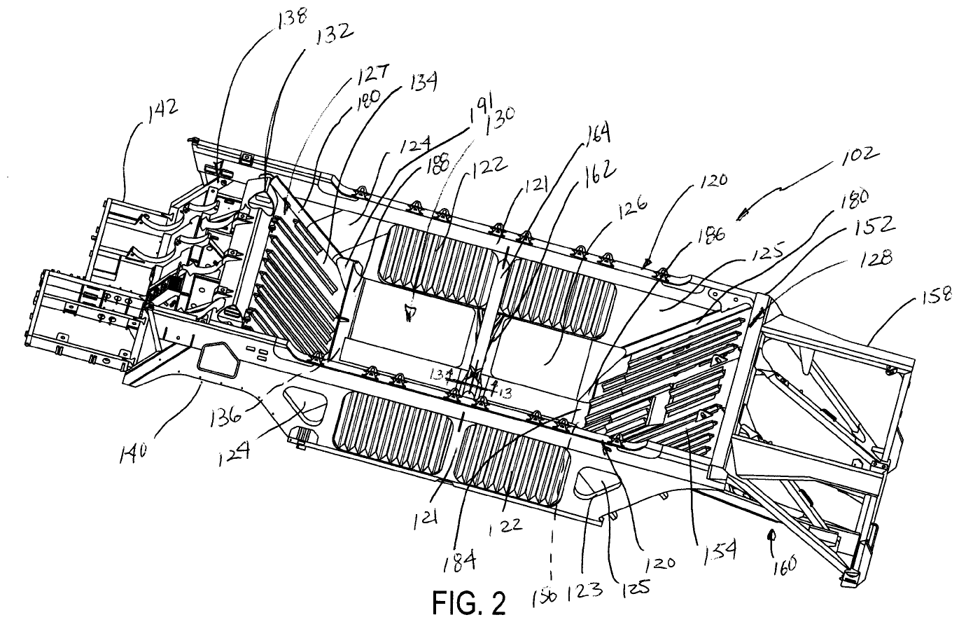

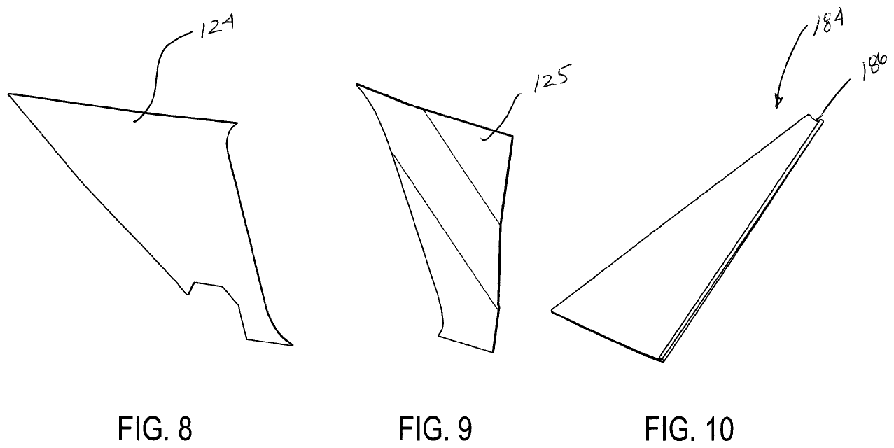

Turning to FIGS. 2-4, there is illustrated an exemplary haul body 102 of the coal hauler 100 of FIG. 1. The haul body 102 includes a pair of side assemblies 120, which include substantially vertical side walls 121 that may have integrity structures such as corrugations 122 and reinforced window structures 123. Reinforcing front inner formed plates 124 (see FIG. 8) and rear inner formed plates 125 (see FIG. 9) may be disposed within the haul body 102 along reinforced window structures 123. The side assemblies 102 may additionally include bottom sloped walls 126 disposed along a bottom portion of the substantially vertical side walls 121.

Front and rear haul body assemblies 127, 128 are secured to the side assemblies 120 to form a coal hauling chamber 130. The front and rear haul body assembly 127, 128 may be formed of any appropriate design.

In the illustrated embodiment, the front haul body assembly 127 includes a front suspension beam 132 from which a front slope sheet 134 slopes downward and inward in forming the coal hauling chamber 130. A front bulkhead 136 maybe provided at the lower end of the front slope sheet 134. A front structure 138 may slope downward and outward from the front suspension beam 132 toward the front end of the coal hauler 100. A front wheel chamber 140 is formed by the front haul body assembly 127 and the side assemblies 120. In at least some embodiments, additional structures may be secured to the front haul body assembly 127, such as additional front supports 142, for further supporting the cab 112.

The illustrated rear haul body assembly 128 includes a rear suspension beam 152 from which a rear slope sheet 154 slopes downward and inward in forming the coal hauling chamber 130. A rear bulkhead 156 maybe provided at the lower end of the rear slope sheet 154. A rear structure 158 may distally outward from the rear suspension beam 152 toward the rear end of the coal hauler 100. Those of skill in the art will appreciate that the rear structure 158 may be utilized to support additional structures, such as the engine 112, for example. As with the front of the haul body 102, a rear wheel chamber 160 is formed by the rear haul body assembly 128 and the side assemblies 120. In at least some embodiments, additional structures may be formed with or secured to the rear haul body assembly 128.

In addition to the front and rear haul body assemblies 127, 128, the side assemblies 120 may be secured together in a central portion by a center bulkhead structure 162, which is further stabilized by a pair of center support tubes 164, 166.

At least one bottom opening 170 of the haul body 102 is formed by side assemblies 120, and the front and rear haul body structures 127, 128. The bottom opening 170 may be selectively blocked by one or more selectively movable doors. In the illustrated embodiment, a pair of selectively movable doors 172, 174 are provided. The selectively movable door(s) 172, 174 may be selectively operated to at least partially uncover the bottom opening 170 to facilitate a bottom dump of material from within the haul body 102. While the selectively movable door(s) 172, 174 may be of any appropriate design and may be selectively opened and closed by any appropriate mechanism, in at least one embodiment the selectively movable door(s) 172, 174 are hingedly coupled along their outer edges to at least one of the side assemblies 120, and/or the front and rear haul body assemblies 127, 128. By way of example only, one or more operative mechanisms such as four bar linkages and/or hydraulic cylinders may be provided to impart the selective movement of the selectively movable door(s) 172, 174. Such operative mechanisms may be appropriately located, such as, for example, within the center bulkhead structure 162.

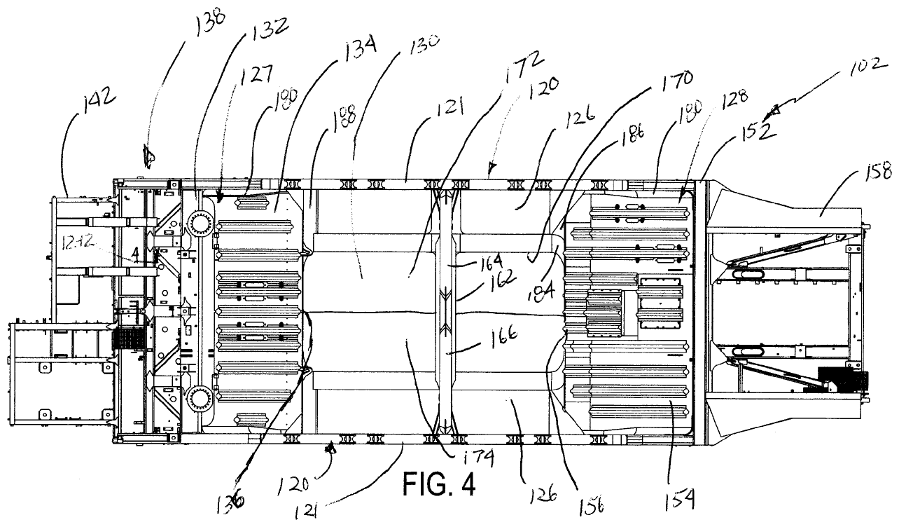

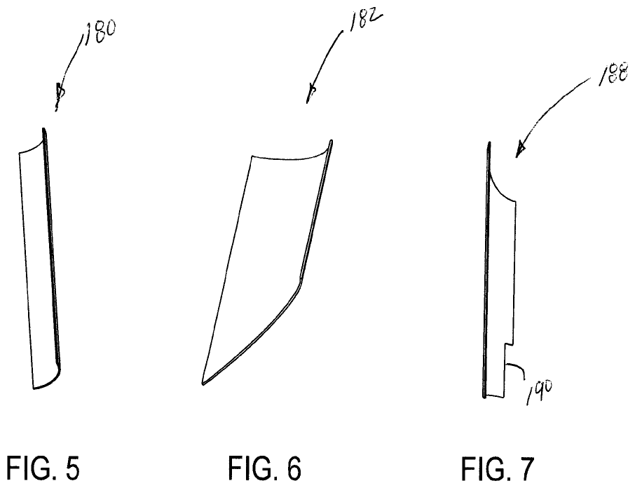

In order to enhance the integrity of the joints formed between the various structures, a plurality of support structures are provided. Referring to FIG. 5, an exemplary side gusset 180 is illustrated. The side gusset 180 is an elongated, curved structure. In the illustrated embodiment, side gussets 180 are utilized in the junction between the front slope sheet 134 of the front haul body assembly 127 and the side assemblies 120, that is, the substantially vertical side walls 121 and the reinforced window structures 123 of the side assemblies 120. Similarly, side gussets 180 are utilized in the junction between the rear slope sheet 154 of the rear haul body assembly 128 and the side assemblies 120, that is, the substantially vertical side walls 121 and the reinforced window structures 123 of the side assemblies 120. While a plurality of side gussets 180 are disposed end to end along an axis, those of skill in the art will appreciate that a single elongated side gusset could alternatively be utilized.

In FIG. 6, an exemplary rear corner wrapper 182 is illustrated, and in FIG. 10, an exemplary conical plate 184 is illustrated. The rear corner wrapper 182 is a somewhat wider, elongated, curved structure than the side gussets 180. The conical plate 184 is a generally trapezoidal structure that includes a minor curve 186 proximal to the smaller end of the trapezoid. In the illustrated embodiment, a rear corner wrapper 182 and a conical plate 184 are positioned end to end, and are disposed in the junction between the rear slope sheet 154 along the rear bulkhead 156, and the bottom sloped wall 126 extending from the substantially vertical side wall 121 of the side assembly 120 along one side of the bottom opening 170. A mirror image rear corner wrapper 182 and conical plate 184 are positioned end to end, and disposed in the junction between the rear slope sheet 154 along the rear bulkhead 156, and the bottom sloped wall 126 extending from the substantially vertical side wall 121 of the opposite side assembly 120 along the opposite side of the bottom opening 170.

An exemplary front corner gusset 188 is illustrated in FIG. 7. The front corner gusset 188 likewise includes an elongated curved structure. The front corner gusset 188 similarly disposed in the junction between the front slope sheet 134 along the front bulkhead 136, and the bottom sloped wall 126 extending from the substantially vertical side wall 121 of the side assembly 120 along one side of the bottom opening 170. A mirror image front corner gusset 188 is disposed in the junction between the front slope sheet 134 along the front bulkhead 136, and the bottom sloped wall 126 extending from the substantially vertical side wall 121 of the opposite side assembly 120 along the opposite side of the bottom opening 170. It will be noted that the front corner gusset 188 includes a longitudinally extending recess 190 that is positioned to conform to the design of the bottom sloped wall 126.

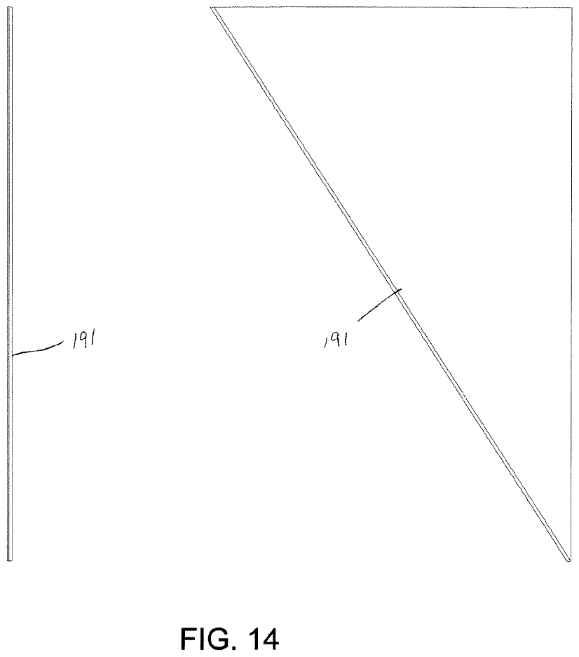

In order to transition between the front corner gusset 188 and the side gusset 180, and the substantially vertical side wall 121 and the front slope sheet 134, a generally triangular plate 191 is provided (see FIG. 14). As with the front corner gusset 188 and the side gusset 180, a mirror image triangular plate 191 is provided along the opposite side of the bottom opening 170.

In order to secure the side assemblies 120 and the front and rear haul body assemblies 127, 128 together, a plurality of welds are provided. While the welds may be of any appropriate design, in at least one embodiment, one or more of the welds are high frequency mechanical impact (HFMI). High frequency mechanical impact (HFMI) is a recent post weld treatment method that can be employed to increase the fatigue strength of welded components.

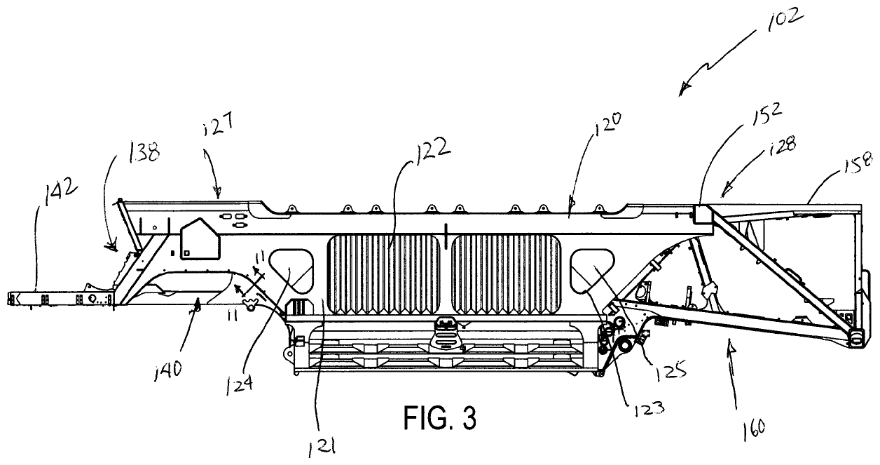

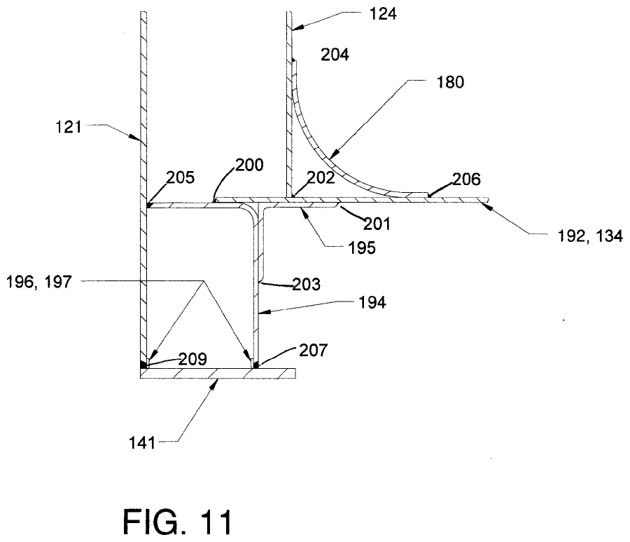

Turning now to FIGS. 11-13, there are illustrated exemplary welded joints. FIG. 11 is an exemplary schematic cross-sectional view of weld structures along curved/conical sections of the haul body 102. More specifically, FIG. 11 illustrates a cross-section taken along line 11-11 in FIG. 3. By way of example of welded joints of this disclosure, a first sheet 192 is welded to a front support structure 194 support at weld 200, and to the front inner formed plate 124 at weld 202. The junction between the first sheet 192 and the front support structure 194 is additionally supported by a support angle 195, which is welded to the first sheet 192 and the front support structure 194 at welds 201, 203, respectively. The front support structure 194 is additionally secured with the substantially vertical sidewall 121, and a front wheel chamber plate 141 at welds 205, 207, and the front wheel chamber plate 140 is welded to the vertical sidewall 121 at weld 209. Those of skill in the art will note that the welds 207, 209 are further supported by backer plates 196, 197.

In order to reinforce this junction of the front support structure 194 and the substantially vertical sidewall 121, and provide added strength to the haul body 102 and the coal hauling chamber 130, the side gusset 180 is positioned within the corner formed between the first sheet 192 of the front slope sheet 134 and the inner formed plate 124 of the substantially vertical sidewall 121. The side gusset 180 is welded to the inner formed plate 124 at weld 204, and the first sheet 192 of the front slope sheet 134 at weld 206. Those of skill in the art will appreciate that the welds 200, 201, 202, 203, 204, 205, 206, 207, 209 each extend along at least a portion of the length of the adjacent components, thereby providing enhanced strength to the structures, as opposed to being merely single spot welds.

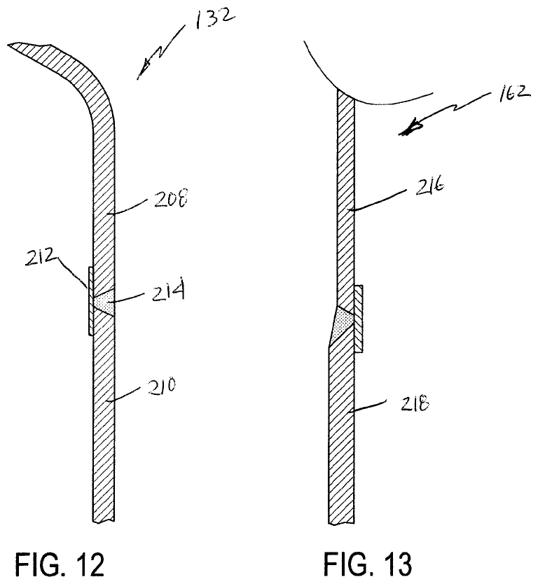

In at least some embodiments, welds are utilized to secure together the edges of components that are of like thickness or of unlike thickness. FIG. 12 is an exemplary schematic cross-sectional view of a weld structure along the front suspension beam 132 of the haul body 102 taken along line 12-12 in FIG. 4. In this arrangement, two like thickness components 208, 210 are provided with a backer 212, and a weld 214 is provided between the components 208, 210. Like welding arrangements are provided between the rear corner wrappers 182, the conical plates 184, and the front corner gussets and respective adjacent components.

FIG. 13 is an exemplary schematic cross-sectional view of a weld structure along the center bulkhead structure 162 of the haul body 102. In this arrangement, however, the components 216, 218 to be joined are of unlike thicknesses. With backer 220 disposed between substantially co-planar surfaces of components 216, 218, a weld 222 is provided between the components 216, 218.

In each of these embodiments, those of skill in the art will appreciate that complete joint penetration between the structures is provided by the weld with the backer. As with the weld arrangement of FIG. 11, those of skill in the art will appreciate that the welds 214, 222 each extend along at least a portion of the length of the adjacent components, thereby providing enhanced strength to the structures, as opposed to being merely single spot welds.

In this way, the welded arrangements provide enhanced strength and durability to the adjacent structures. According to at least some embodiments, the haul body 102 does not include a separate support frame on which the haul body 102 is disposed or coupled. Rather, the haul body 102 is a unitized construction.

In at least some embodiments, reinforcing structures are welded in place along the elongated junctions between the front and rear haul body assemblies 127, 128 and adjacent side wall assemblies 120. While the components may be otherwise coupled as well, these reinforcing structures which are welded in place reinforce, strengthen and provide integrity to the haul body 102. Such reinforcing structures may be disposed in the interior of the haul body 102, as illustrated. In at least some embodiments, at least a portion of the welds are treated by a high frequency mechanical impact (HFMI) treatment method. In at least some embodiments, all welds are treated by a high frequency mechanical impact (HFMI) treatment method.

### INDUSTRIAL APPLICABILITY

The present disclosure is applicable to coal hauler used to transport large volumes of coal. Some embodiments constructed in accordance with teachings of this disclosure may provide enhanced productivity and greater operator efficiency in that the coal hauler may transport a heavier payload in each operation. At least some to embodiments may provide a lower empty vehicle weight and enhanced payload-to-weight ratio. Some embodiments may provide greater fuel efficiency.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A coal hauler comprising:
a plurality of ground engaging members;
a motivator configured to provide a driving force to at least one of the ground engaging members;
a haul body, the haul body being supported on the ground engaging members, the haul body including
a pair of side assemblies, which include substantially vertical side walls,
a front haul body assembly,
a rear haul body assembly, the front and rear haul body assemblies being secured to the side assemblies to form a coal hauling chamber.
the front and rear haul body assemblies, the side assemblies coupled together in a central portion by a center bulkhead structure,
at least one bottom opening formed by the side assemblies, and the front and rear haul body assemblies,
at least one selectively movable door selectively blocking the bottom opening to at least partially uncover the bottom opening to facilitate a bottom dump of material from within the haul body,
a plurality of support structures including
at least one front support structure secured between each side assembly and the front haul body assembly along the coal hauling chamber,
at least one rear support structure secured between each side assembly and the rear haul body assembly along the coal hauling chamber,
wherein said front and rear support structures reinforce intersections of the front and rear haul body assemblies with the side assemblies along the coal hauling chamber.

2. The coal hauler of claim 1 wherein substantially an entire length of an intersection between the side assembly and the front haul body assembly is reinforced by said at least one front support structure.

3. The coal hauler of claim 1 wherein substantially an entire length of an intersection between the side assembly and the rear haul body assembly is reinforced by said at least one rear support structure.

4. The coal hauler of claim 1 wherein the side assemblies include substantially vertical side walls and bottom sloped walls.

5. The coal hauler of claim 4 wherein substantially an entire length of an intersection between the substantially vertical side walls and the bottom sloped walls of the side assembly and the front haul body assembly is reinforced by said at least one front support structure.

6. The coal hauler of claim 4 wherein substantially an entire length of an intersection between the substantially vertical side walls and the bottom sloped walls of the side assembly and the rear haul body assembly is reinforced by said at least one rear support structure.

7. The coal hauler of claim 1 wherein the at least one front support structure includes at least two of an elongated side gusset, a generally triangular sheet, and a front corner gusset 188.

8. The coal hauler of claim 1 wherein the at least one rear support structure includes an elongated side gusset and a conical plate 184.

9. The coal hauler of claim 1 including at least one weld between said at least one front support structure and each side assembly and the front haul body assembly, and said at least one rear support structure and each side assembly and the rear haul body assembly along the coal hauling chamber.

10. The coal hauler of claim 1 including high frequency mechanical impact weld between at least one of said at least one front support structure and each side assembly and the front haul body assembly, and said at least one rear support structure and each side assembly and the rear haul body assembly along the coal hauling chamber.

11. The coal hauler of claim 9 wherein at least one of said welds includes a backer plate.

12. The coal hauler of claim 9 the welds each extend along at least a portion of the length of adjacent components.

13. The coal hauler of claim 1 wherein the haul body does not include a separate support frame on which the haul body is disposed or coupled.

14. (canceled)
